(19) United States
(12) Patent Application Publication
(10) Pub. No.: US 2019/0030974 A1
(43) Pub. Date: Jan. 31, 2019

(54) FRONT LIFTING SYSTEM FOR VEHICLE

(71) Applicants: YU-JUI YANG, New Taipei (TW); Ju Ying Yu, New Taipei (TW)

(72) Inventors: YU-JUI YANG, New Taipei (TW); Ju Ying Yu, New Taipei (TW)

(21) Appl. No.: 15/662,296

(22) Filed: Jul. 28, 2017

(51) Int. Cl. B60G 15/06; B60G 11/16; B60G 17/016; F16F 9/32

(52) U.S. Cl. CPC B60G 15/063; B60G 11/16; B60G 15/067; B60G 2206/911; F16F 9/3207; B60G 2204/12; B60G 17/016

(57) ABSTRACT

A front lifting system for vehicle comprises a threaded pipe, an annular hydraulic unit, and a fixing base. When the threaded pipe covers a shock absorber, a spring covers a damper of the shock absorber and two ends of the spring are respectively abutted against the annular hydraulic unit and the damper. At this time, the annular hydraulic unit does not act. When the annular hydraulic unit acts, it pushes the spring upwardly and further the spring pushes the damper upwardly so that the front of the vehicle may be lifted up to prevent the front of the vehicle with lower chassis from damage while going uphill or downhill.

### FIELD OF THE INVENTION

The present invention relates to a lifting system, and more particularly to a front lifting system for vehicle.

### BACKGROUND OF THE INVENTION

The general cars, race cars, or modified sports cars are provided for improving the control stability and decreasing the air resistance while driving. Therefore, the height of the chassis of each above car is lowered. However, after the chassis is lowered, the chassis may collide with the ground while going uphill or downhill, or driving through the bumpy road or the road hump. It may result in damaging the chassis and the lower edge of the front bumper.

The high-class cars may have their own OEM Electronic Damping System so as to adapt different grounds. Due to the low chassis which is close to the ground, the front of the car (vehicle) may touch the ground to be damaged when the car goes uphill or downhill. In order to prevent the front of the car (vehicle) from touching ground to damage the chassis and the lower edge of the bumper, the OEM electronic damping system may be arranged at the front of the car (vehicle) or the body of the car (vehicle) and the front of the car (vehicle) or the body of the car (vehicle) may be lifted up by the OEM electronic damping system. That is, when the car (vehicle) goes uphill or downhill, a control key may be pressed down to control the electronic damping system to lift up a predetermined distance and be back to original height while going to the level ground.

However, the cars (vehicles) with the electronic damping system are high-class cars (vehicles). They are very expansive. If they need to replace the electronic damping system to lift up the front or the body of the car (vehicle), it needs to take another high cost and makes the cost very high.

In view of the foregoing circumstances, the inventor has invested a lot of time to study the relevant knowledge, compare the pros and cons, research and develop related products. After quite many expetireents and tests, the “front lifting system for vehicle” of this invention is eventually launched to improve the foregoing shortcomings, to meet the public use.

### SUMMARY OF THE INVENTION

An object of this invention is providing a front lifting system for vehicle. The threaded pipe which is made of an aluminum material directly covers the original shock absorber of the OEM (Original Equipment Manufacturer) Electronic Damping System and then the outer threading portion of the threaded pipe is screwed with the ring base, the annular hydraulic unit, and the fixing base. It may suitable for the shock absorbers of different OEM Electronic Damping Systems. The OEM Electronic Damping Systems may be not replaced so as to decrease the cost.

To achieve above objects, a front lifting system for vehicle may comprise a threaded pipe, covering a shock absorber; wherein the shock absorber has at least one shoulder portion; and wherein at least one step portion is formed at an inner surface of the threaded pipe, the at least one step portion is abutted against the at least one shoulder portion of the shock absorber.

In some embodiments, the front lifting system for vehicle may further comprise a ring base, the ring base has an inner threading portion, the threaded pipe has an outer threading portion formed at an outer surface thereof, and the inner threading portion is screwed with the outer threading portion for adjusting upwardly and downwardly.

In some embodiments, the front lifting system for vehicle may further comprise an annular hydraulic unit, the annular hydraulic unit covers the threaded pipe and is abutted against an upper surface of the ring base.

In some embodiments, the front lifting system for vehicle may further comprise a fixing base for connecting a stabilizer link, the fixing base is screwed with the threaded pipe and located below the ring base.

In some embodiments, the ring base is separated from the fixing base with a predetermined distance, and the predetermined distance is adjusted by screwing the ring base relative to the threaded pipe.

In some embodiments, the threaded pipe is made of an aluminum material.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a perspective view of a front lifting system for vehicle of the present invention.

FIG. 2 is an exploded view of the front lifting system for vehicle of the present invention.

FIG. 3 is a cross-sectional view of a first embodiment of the front lifting system for vehicle of the present invention.

FIG. 4 is a cross-sectional view of the first embodiment of the front lifting system for vehicle of the present invention while lifting upwardly.

FIG. 5 is a side view of the first embodiment of the front lifting system for vehicle of the present invention which is assembled to a shock absorber.

FIG. 6 is a plan view of the first embodiment of the front lifting system for vehicle of the present invention which is assembled to a shock absorber.

FIG. 7 is a cross-sectional view of a second embodiment of the front lifting system for vehicle of the present invention.

FIG. 8 is a cross-sectional view of the second embodiment of the front lifting system for vehicle of the present invention which is assembled to a shock absorber.

### DESCRIPTION OF THE PREFERRED EMBODIMENT

Referring now to the drawings where like characteristics and features among the various figures are denoted by like reference characters.

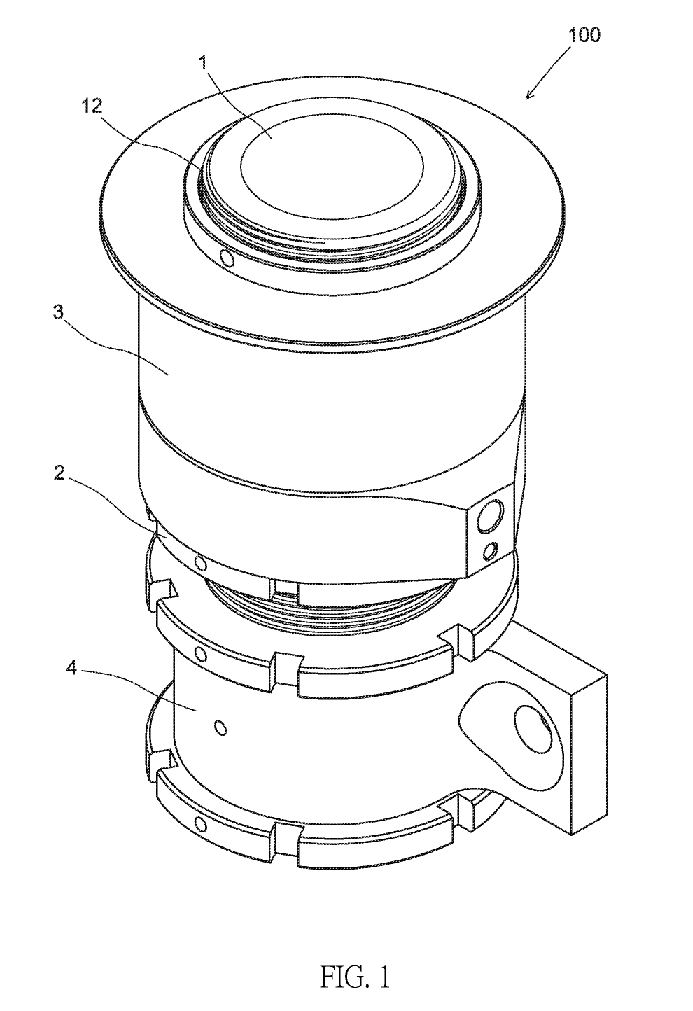

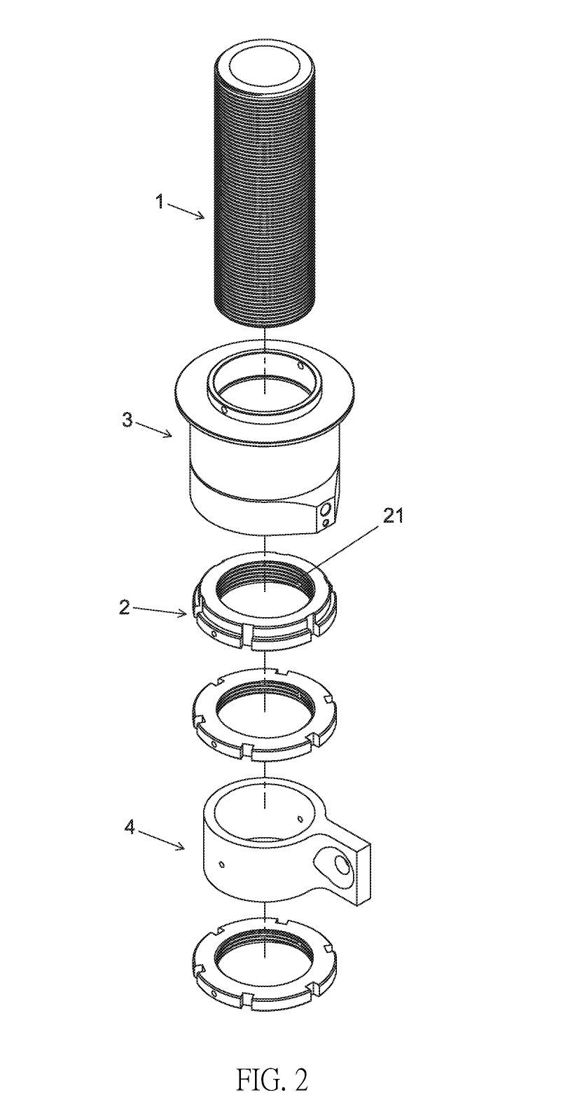

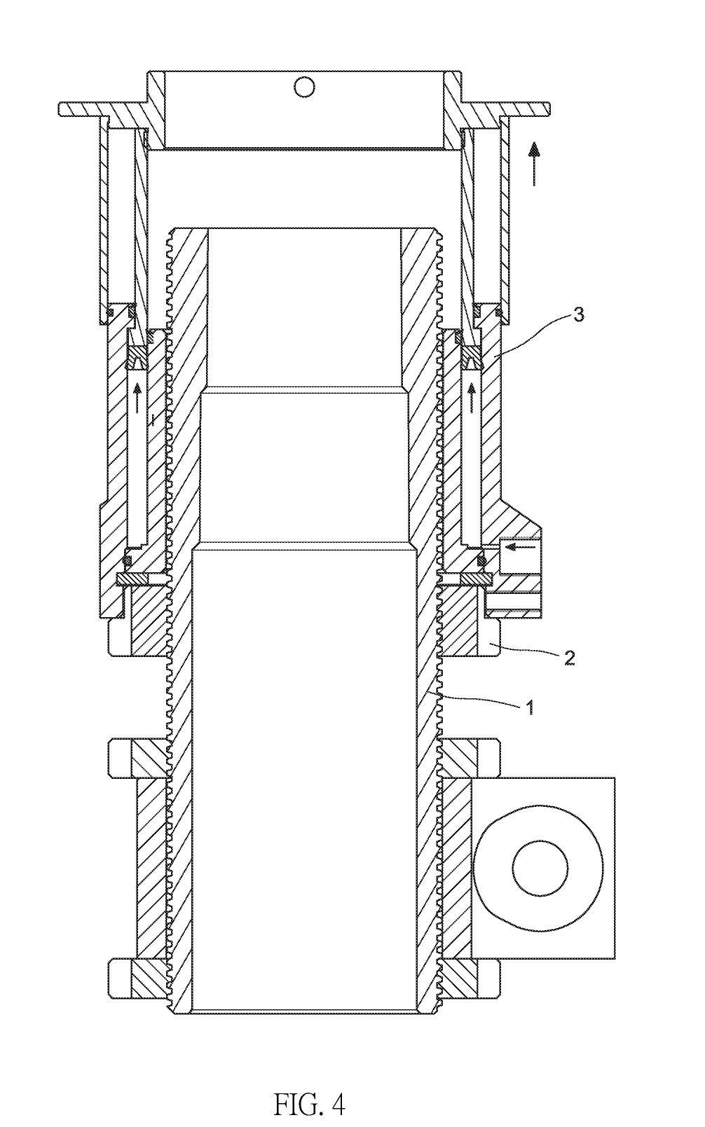

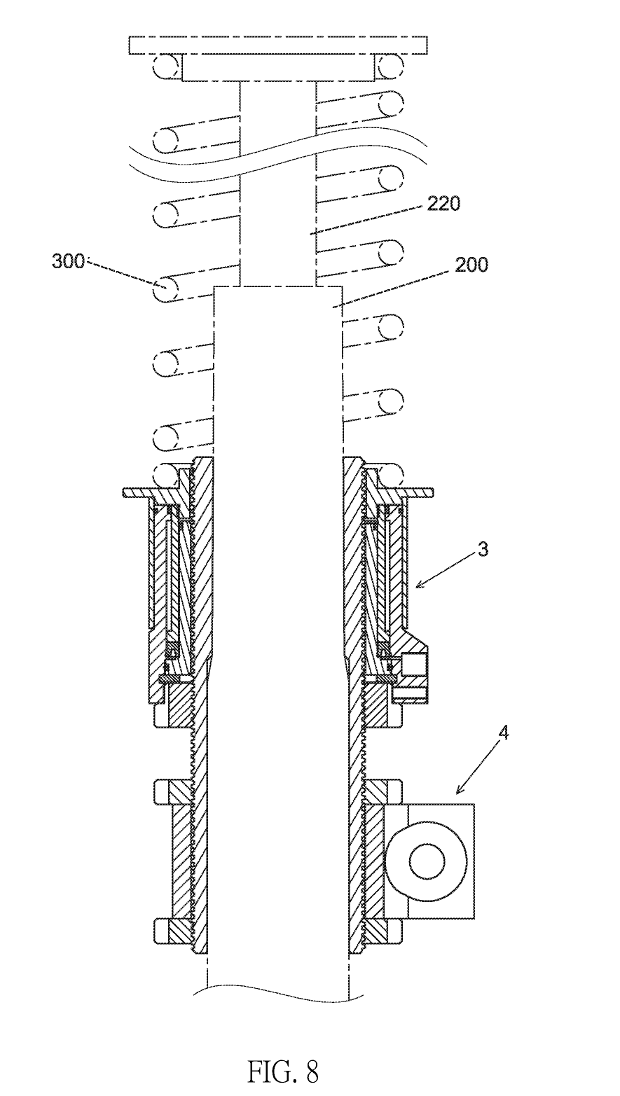

Please refer to FIGS. 1 to 8, a front lifting system 100 for vehicle may comprise a threaded pipe 1 which is made of an aluminum material, but not limited thereof.

The threaded pipe 1 may cover a shock absorber 200 which is suitable for the Electronic Damping System.

The shock absorber 200 has at least one shoulder portion 210. At least one step portion 11 is formed at an inner surface of the threaded pipe 1. The at least one step portion 11 is abutted against the at least one shoulder portion 210 of the shock absorber 200.

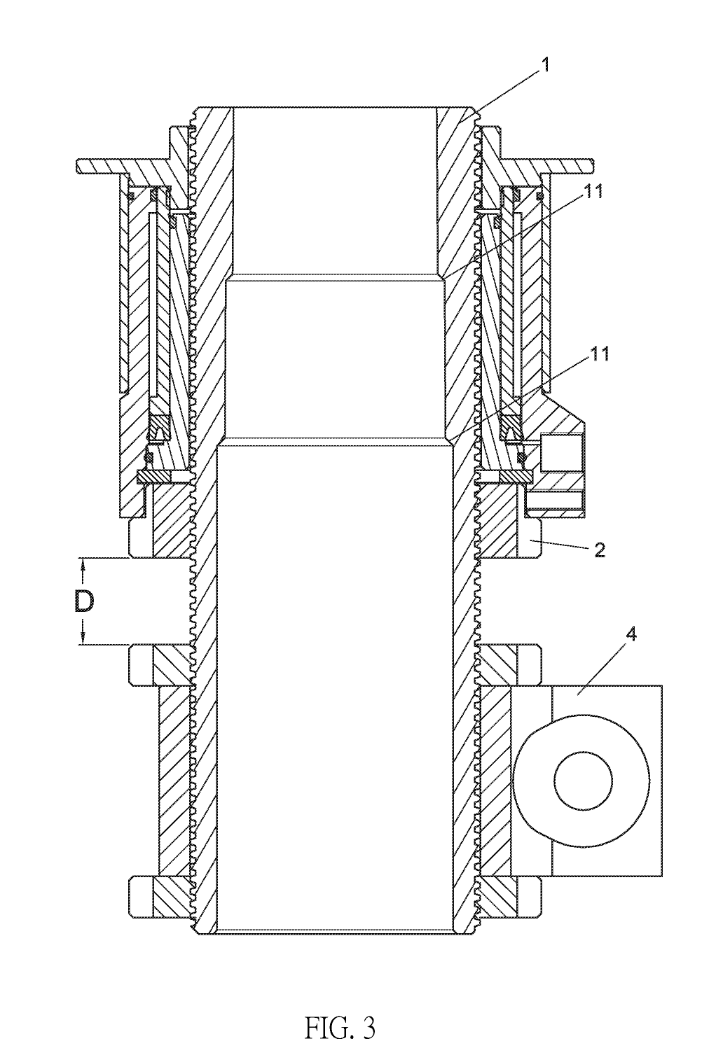

Please refer to FIG. 3, it shows a first embodiment of the front lifting system 100 for vehicle. There are two step portions 11 and two shoulder portions 210 whose quantity is corresponding to the quantity of the step portions 11.

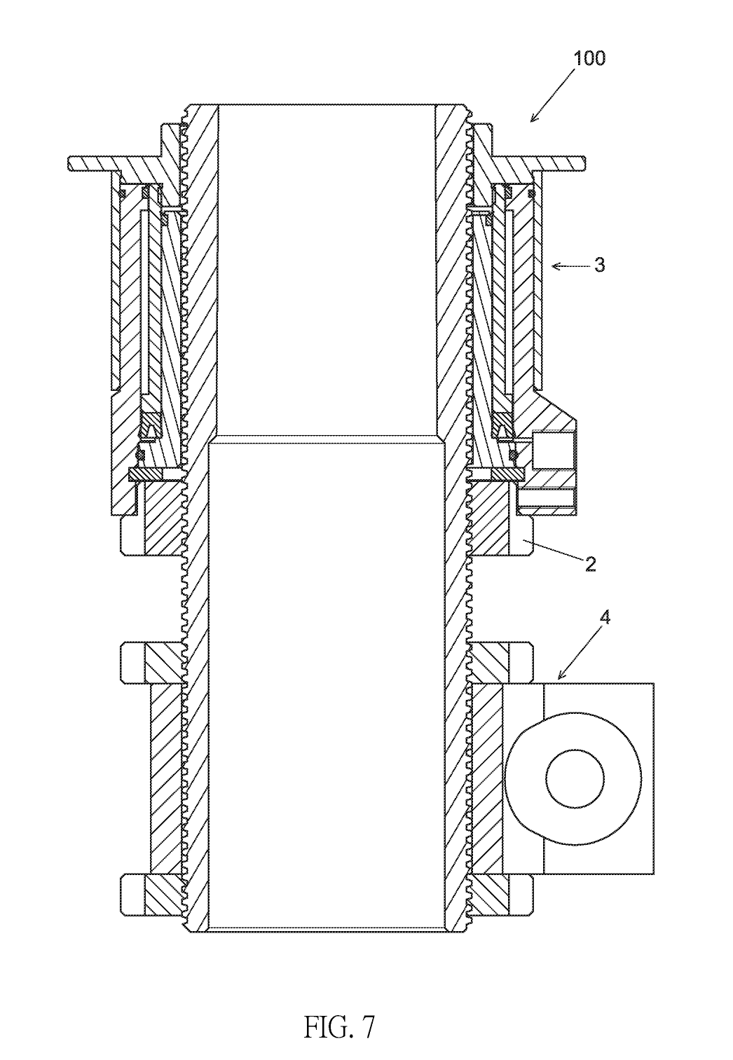

Please refer to FIG. 7, it shows a second embodiment of the front lifting system 100 for vehicle. There is single one step portion 11 and single one shoulder portion 210 whose quantity is corresponding to the quantity of the step portion 11.

The front lifting system 100 for vehicle may further comprise a ring base 2. The ring base 2 has an inner threading portion 21. The threaded pipe 1 has an outer threading portion 12 formed at an outer surface thereof. The inner threading portion 21 is screwed with the outer threading portion 12 for adjusting upwardly and downwardly.

The front lifting system 100 for vehicle may further comprise an annular hydraulic unit 3. The annular hydraulic unit 3 covers the threaded pipe 1 and is abutted against an upper surface of the ring base 3. That is, the annular hydraulic unit 3 is located above the ring base 2.

The front lifting system 100 for vehicle may further comprise a fixing base 4 for connecting a stabilizer link (not shown). The fixing base 4 is screwed with the threaded pipe 1 and located below the ring base 2. The fixing base 4 may be moved upwardly and downwardly relative to the threaded pipe 1 by screwing so as to adapt the lengths of stabilizer links (not shown) of different kinds of vehicles.

In addition, the ring base 2 is separated from the fixing base 4 with a predetermined distance D (shown as in FIG. 3). The predetermined distance D may be adjusted by screwing the ring base 2 relative to the threaded pipe 1.

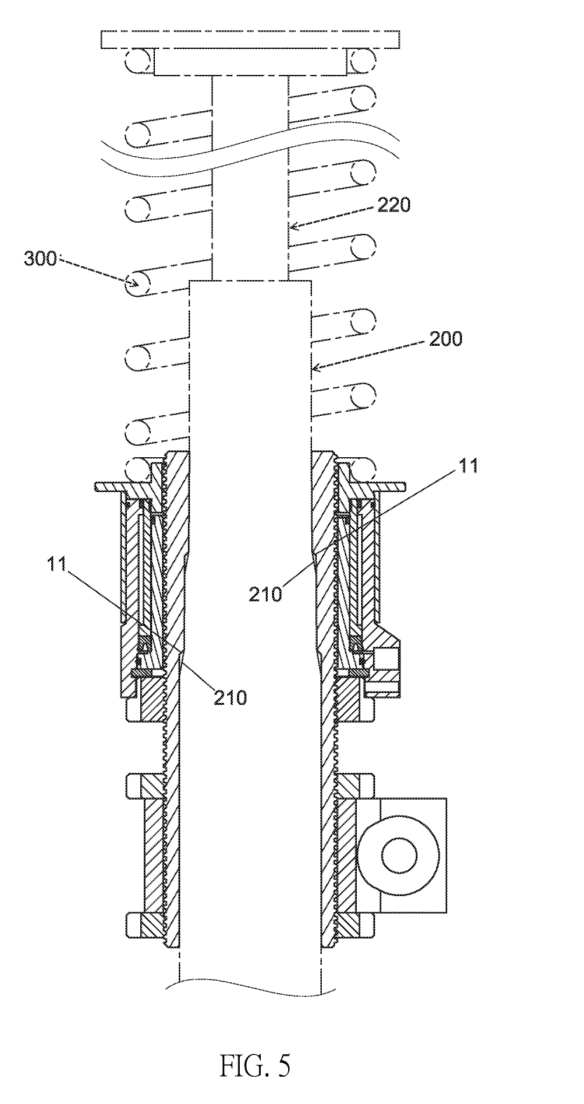

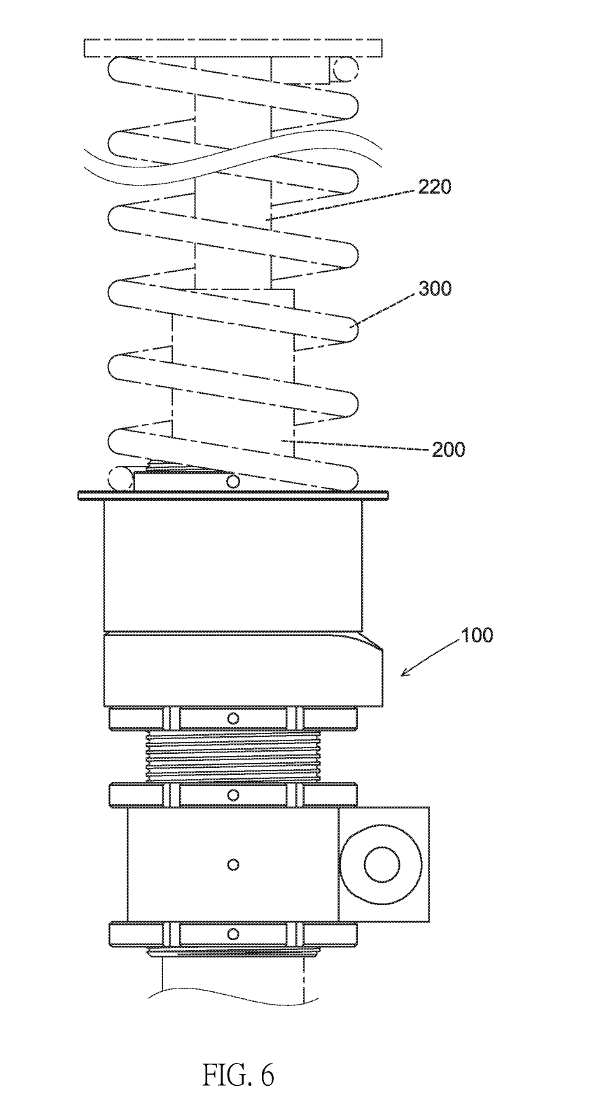

Please refer to FIGS. 5 and 6, when the threaded pipe 1 covers the shock absorber 200, a spring 300 covers a damper 220 of the shock absorber 200 and two ends of the spring 300 are respectively abutted against the upper surface of the annular hydraulic unit 3 and the end of the damper 200 which is distant from the annular hydraulic unit 3. At this time, the annular hydraulic unit 3 does not act. Please refer to FIG. 7, when the annular hydraulic unit 3 acts, the annular hydraulic unit 3 pushes the spring 300 upwardly and further the spring 300 pushes the damper 220 upwardly so that the front of the vehicle (not shown) may be lifted up to prevent the front of the vehicle with lower chassis from damage while going uphill or downhill.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A front lifting system for vehicle, comprising:
a threaded pipe adapted to cover an existed shock absorber which has at least one shoulder portion, the threaded pipe having an outer threading portion formed at an outer surface thereof;
at least one step portion formed at an inner surface of the threaded pipe, the at least one step portion is adapted to be abutted against the at least one shoulder portion of the existed shock absorber;
a ring base having an inner threading portion, the inner threading portion is screwed with the outer threading portion of the threaded pipe, the ring base being moved upward and downwardly by being threaded relative to the threaded pipe;
an annular hydraulic unit mounted to the threaded pipe and being abutted against an upper surface of the ring base;
a fixing base adapted to be connected with a stabilizer link, the fixing base screwed with the threaded pipe and located below the ring base.

2. (canceled)

3. (canceled)

4. (canceled)

5. The front lifting system for vehicle as claimed in claim 1, wherein the ring base is separated from the fixing base with a predetermined distance, and the predetermined distance is adjusted by screwing the ring base relative to the threaded pipe.

6. The front lifting system for vehicle as claimed in claim 1, wherein the threaded pipe is made of an aluminum material.
